(19) United States
(12) Patent Application Publication
(10) Pub. No.: US 2022/0333438 A1
(43) Pub. Date: Oct. 20, 2022

(54) SUPPORT STRUCTURE AND ELECTRICALLY-DRIVEN WINDOW SHADE INCLUDING THE SAME

(71) Applicant: Teh Yor Co., Ltd., New Taipei City (TW)

(72) Inventors: Chung-Chen HUANG, New Taipei City (TW); Kuan-Yu LIU, New Taipei City (TW)

(73) Assignee: Teh Yor Co., Ltd., New Taipei City (TW)

(21) Appl. No.: 17/234,179

(22) Filed: Apr. 19, 2021

(51) Int. Cl. E06B 9/323; E06B 9/322

(52) U.S. Cl. CPC E06B 9/323; E06B 9/322

(57) ABSTRACT

A support structure includes a rail configured to provide support for a shading structure of an electrically-driven window shade, the rail having a cavity adapted to receive an electric motor and being fixedly connected with a battery case holder having a plurality of first electric connectors, and a battery case having a plurality of second electric connectors, the battery case having an interior configured to receive one or more battery cells. The battery case is removable from the battery case holder and the rail for accessing to the interior of the battery case, and is connectable with the battery case holder so that the first electric connectors respectively contact with the second electric connectors for supplying electric power through the first and second electric connectors to an electric motor installed in the cavity of the rail.

### BACKGROUND

### 1. Field of the Invention

The present invention relates to electrically-driven window shades and its support structure.

### 2. Description of the Related Art

Electrically-driven window shades generally use an electric motor for raising and lowering the shade. In some available products, the electric motor and battery cells used for powering the electric motor are placed inside a support structure of the window shade, which is typically affixed at a top of a window opening. Owing to the height of the support structure, it may be difficult for a user to access the support structure and replace the battery cells.

Therefore, there is a need for an improved design that is more convenient in use and address at least the foregoing issues.

### SUMMARY

The present application describes a support structure for an electrically-driven window shade that is more convenient in use and can facilitate the replacement of battery cells.

According to an embodiment, the support structure includes a rail configured to provide support for a shading structure of an electrically-driven window shade, the rail having a cavity adapted to receive an electric motor and being fixedly connected with a battery case holder having a plurality of first electric connectors, and a battery case having a plurality of second electric connectors, the battery case having an interior configured to receive one or more battery cells. The battery case is removable from the battery case holder and the rail for accessing to the interior of the battery case, and is connectable with the battery case holder so that the first electric connectors respectively contact with the second electric connectors for supplying electric power through the first and second electric connectors to an electric motor installed in the cavity of the rail.

The present application also provides an electrically-driven window shade. According to an embodiment, the electrically-driven window shade includes the support structure, a shading structure connected with the rail of the support structure, and an electric motor disposed inside the rail of the support structure, wherein the electric motor is operable to expand the shading structure away from the rail of the support structure or retract the shading structure toward the rail of the support structure.

### BRIEF DESCRIPTION OF THE DRAWINGS

FIG. 1 is a perspective view illustrating an embodiment of an electrically-driven window shade;

FIG. 2 is a top view illustrating the electrically-driven window shade of FIG. 1;

FIG. 3 is an exploded view illustrating the construction of a winding unit provided in the electrically-driven window shade;

FIG. 4 is an exploded view illustrating construction details of a battery case and a battery case holder provided in the electrically-driven window shade of FIG. 1;

FIG. 5 is a perspective view illustrating the battery case holder of FIG. 4 fixedly attached to an end of a rail as provided in the electrically-driven window shade of FIG. 1;

FIG. 6 is a perspective view illustrating the battery case holder of FIG. 4 alone;

FIG. 7 is a perspective view illustrating the battery case of FIG. 4 alone;

FIGS. 8 and 9 are perspective views illustrating a housing of the battery case of FIG. 4 under two different angles of views;

FIG. 10 is a partial cross-sectional view illustrating the placement of electric connectors in the housing of the battery case;

FIG. 11 a cross-sectional view illustrating the battery case and the battery case holder of FIG. 4 connected with each other;

FIG. 12 is a schematic view illustrating exemplary operation for installing the battery case onto the rail in the electrically-driven window shade of FIG. 1;

FIG. 13 is an enlarged view of a portion of FIG. 12 illustrating a latch engaged with an anchoring portion for locking the battery case in position relative to the rail and the battery case holder;

FIG. 14 is a cross-sectional view illustrating some details of the connection between the battery case and the battery case holder in the electrically-driven window shade of FIG. 1;

FIG. 15 is a perspective view illustrating another embodiment of an electrically-driven window shade;

FIG. 16 is a top view illustrating the electrically-driven window shade of FIG. 15;

FIG. 17 is an exploded view illustrating construction details of a battery case and a battery case holder used in the electrically-driven window shade of FIG. 15;

FIG. 18 is a partial cross-sectional view illustrating the battery case and the battery case holder of FIG. 17 connected with each other;

FIG. 19 is a partial cross-sectional view taken along a sectional plane perpendicular to that of FIG. 18;

FIGS. 20-22 are schematic views illustrating exemplary operation for installing the battery case onto the rail in the electrically-driven window shade of FIG. 15;

FIGS. 23 and 24 are perspective views illustrating a variant construction in which a casing of the battery case holder has a cover pivotally attached thereto for closing and opening the casing;

FIGS. 25 and 26 are perspective views illustrating another variant construction in which the cover is fixedly connected with the battery case;

FIGS. 27-29 are perspective views another variant construction in which the cover is fixedly connected with the battery case and the casing of the battery case holder includes a hinge support portion connectable with the battery case;

FIG. 30 is a perspective view illustrating another construction of a battery case and a battery case holder that may be provided in a support structure of a window shade;

FIG. 31 is an exploded view illustrating some construction details of the battery case and the battery case holder used in the support structure shown in FIG. 30;

FIG. 32 is a schematic view illustrating further construction details of the battery case and the battery case holder used in the support structure shown in FIG. 30;

FIGS. 33-35 are schematic views illustrating exemplary operation for installing the battery case holder and the battery case of the support structure shown in FIG. 30;

FIGS. 36-40 are schematic views illustrating a variant construction in which the battery case holder further includes a latch mechanism for locking the battery case in position;

FIGS. 41-44 are schematic views illustrating a variant construction of a latch mechanism provided on the battery case holder for locking the battery case in position; and

FIGS. 45 and 46 are schematic views illustrating exemplary operation of the latch mechanism shown in FIGS. 41-44.

### DETAILED DESCRIPTION OF THE EMBODIMENTS

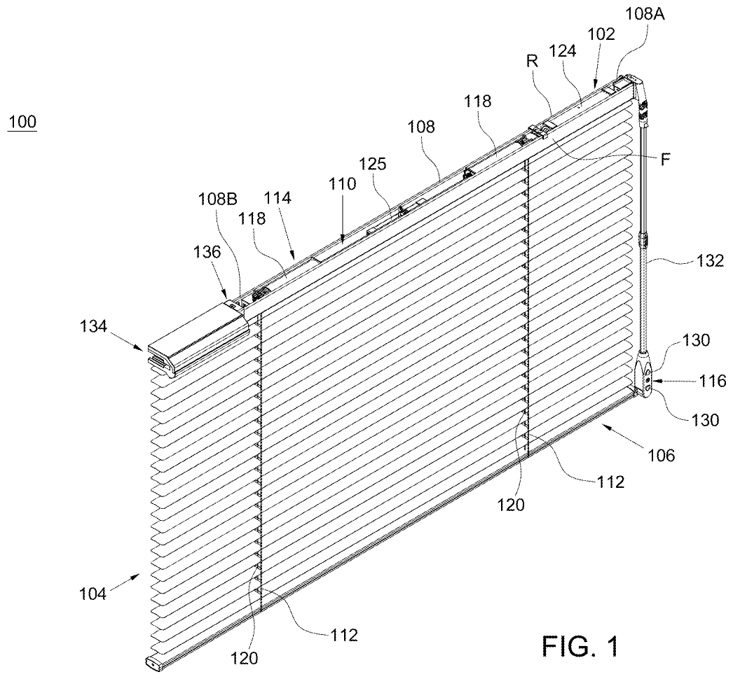

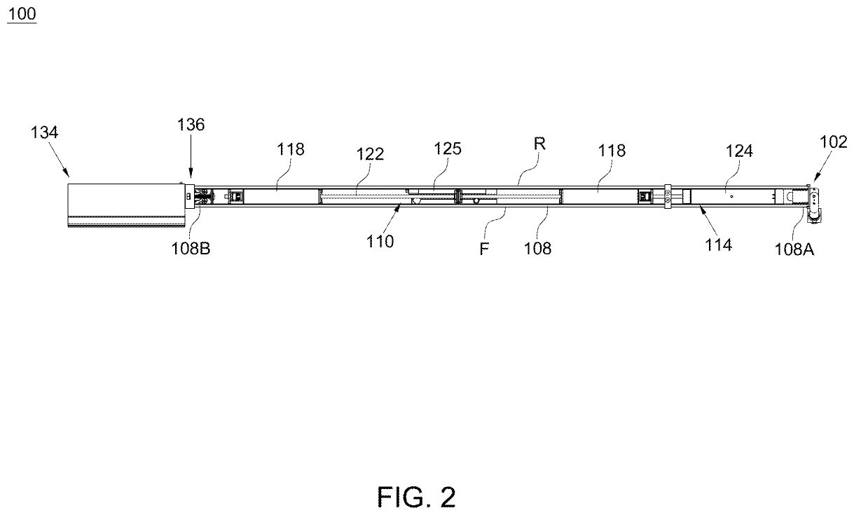

FIGS. 1 and 2 are respectively a perspective view and a top view illustrating an embodiment of an electrically-driven window shade 100. Referring to FIGS. 1 and 2, the electrically-driven window shade 100 can include a support structure 102, a shading structure 104 and a movable rail 106. The support structure 102 can include a rail 108 configured to provide support for the shading structure 104 and the movable rail 106. The rail 108 can be of an elongate shape provided with a cavity 110, and can have two opposite ends 108A and 108B, and a front surface F and a rear surface R opposite to each other. The cavity 110 may extend continuously from the end 108A to the end 108B of the rail 108, and may be delimited at least partially between the front surface F and the rear surface R of the rail 108. In a use configuration, the rail 108 can be affixed to a wall at a top of a window opening with the front surface F facing indoor, and the shading structure 104 and the movable rail 106 can be connected with and suspended from the rail 108.

According to an example of construction, the shading structure 104 can include a plurality of slats, and the shading structure 104 and the movable rail 106 can be connected with the rail 108 via a plurality of suspension elements 112, wherein the suspension elements 112 can exemplarily include ladder cords that are respectively connected with the rail 108, the shading structure 104 and the movable rail 106. It will be appreciated, however, that the shading structure 104 may have other structures. For example, other constructions for the shading structure 104 may include, without limitation, a honeycomb panel, an assembly of fabric vanes disposed generally parallel to one another, and the like.

Referring to FIGS. 1 and 2, the electrically-driven window shade 100 can further include an actuating mechanism 114 operable to expand and retract the shading structure 104, and a control interface 116 operatively connected with the actuating mechanism 114. The actuating mechanism 114 can include a plurality of winding units 118, suspension cords 120 respectively coupled to the winding units 118, a rotary axle 122, an electric motor 124 and a motor controller 125.

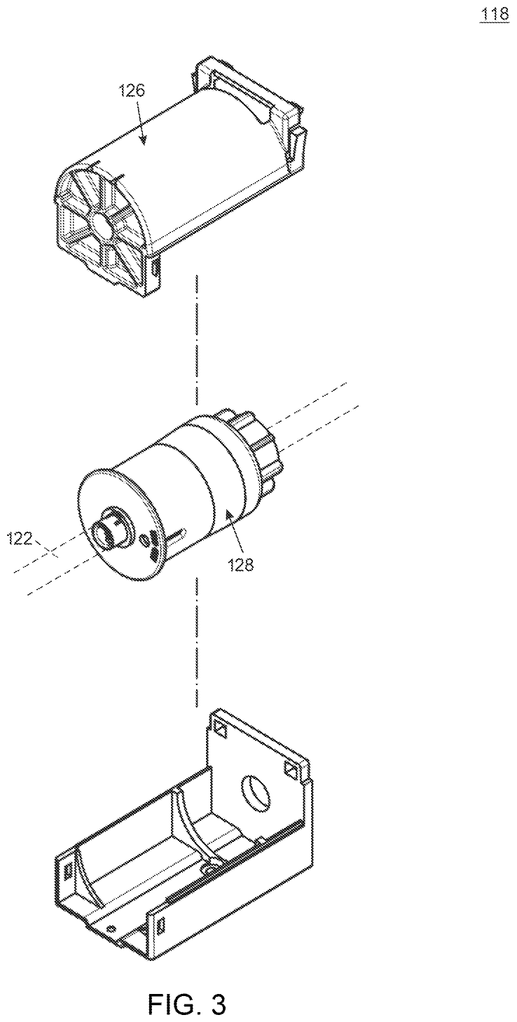

The winding units 118 can be disposed in the cavity 110 of the rail 108 at spaced-apart positions, and can be assembled coaxially about the rotary axle 122. FIG. 3 is an exploded view illustrating the construction of the winding unit 118. The winding unit 118 can exemplarily include a casing 126, and a drum 128 pivotally assembled with the casing 126 and rotationally coupled to the rotary axle 122. All the winding units 118 thereby can be rotationally coupled to the rotary axle 122.

The suspension cords 120 can pass through holes provided in the shading structure 104, each suspension cord 120 having an upper end connected with the drum 128 of one corresponding winding unit 118 and a lower end connected with the movable rail 106. The movable rail 106 can be thereby suspended vertically below the rail 108.

The rotary axle 122 can be assembled through the drums 128 of the winding units 118, whereby the rotary axle 122 and the drums 128 can rotate in unison.

The electric motor 124 can be disposed in the cavity 110 of the rail 108 adjacent to the end 108A of the rail 108, and can have an output rotationally coupled to the rotary axle 122. According to an example of construction, the electric motor 124 can be a DC motor. The electric motor 124 is coupled to the motor controller 125, and is operable to drive the rotary axle 122 in rotation for expanding the shading structure 104 away from the rail 108 or retracting the shading structure 104 toward the rail 108 via a displacement of the movable rail 106.

The control interface 116 can be electrically connected with the motor controller 125, and is operable to control the operation of the electric motor 124. For example, the control interface 116 can include a plurality of buttons 130 operable to control the rotation of the electric motor 124 in either direction via the motor controller 125. The control interface 116 can be electrically connected with the motor controller 125 via a cable assembly (not shown) that is routed through a hollow wand 132. The hollow wand 132 can have a first end pivotally connected with the rail 108 adjacent to the end 108A thereof, can extend vertically downward from the rail 108, and can have a second end fixedly secured with the control interface 116.

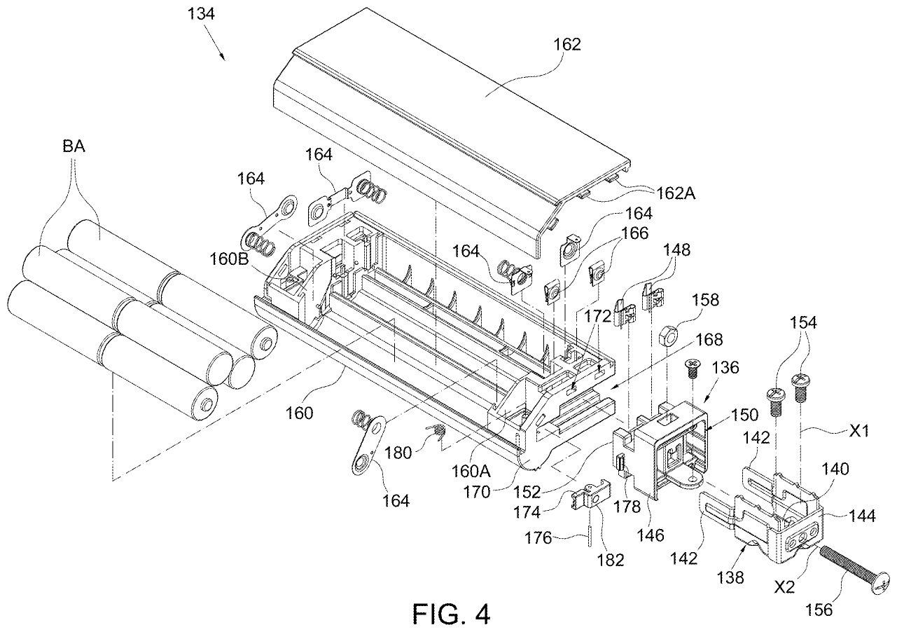

Referring to FIGS. 1 and 2, the support structure 102 can further include a battery case 134 having an interior configured to receive one or more battery cells BA (better shown in FIG. 4) for supplying electric power to the electric motor 124 and the motor controller 125 installed in the rail 108. The battery case 134 is detachably connected with the rail 108. For example, the rail 108 is fixedly connected with a battery case holder 136, and the battery case 134 can be connected with and removed from the battery case holder 136 as desired. The battery case holder 136 can be provided at the end 108B of the rail 108, and the battery case 134 can be connected with the battery case holder 136 outside the rail 108.

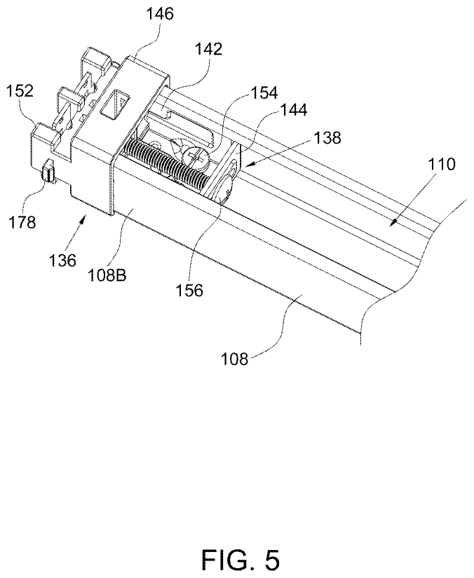

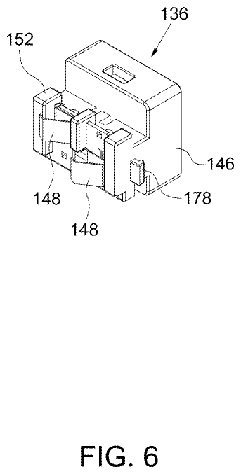

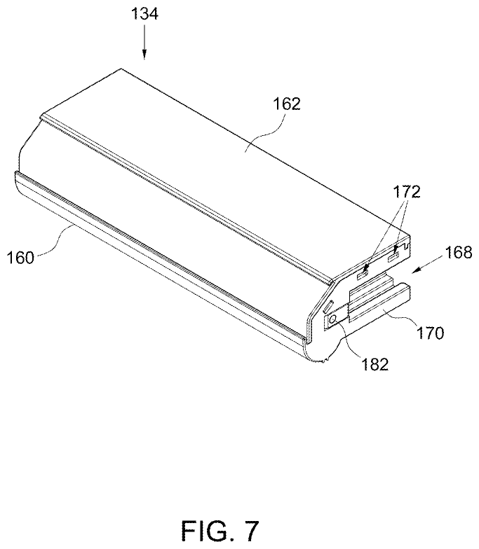

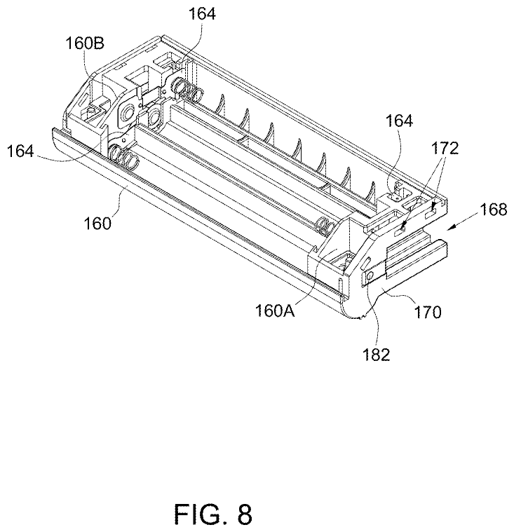

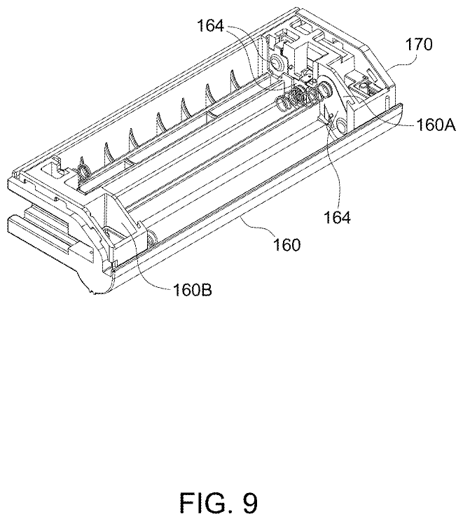

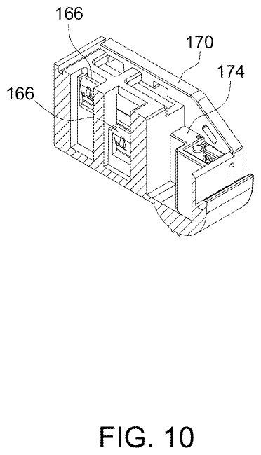

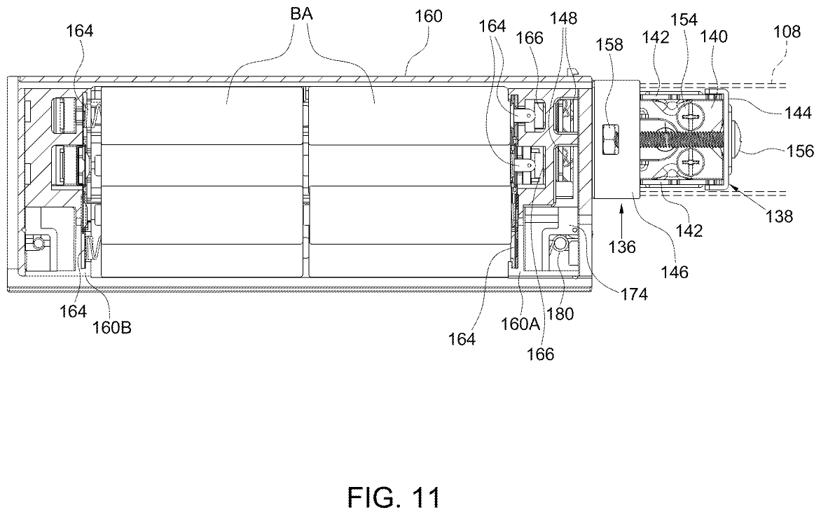

In conjunction with FIGS. 1 and 2, FIGS. 4-11 illustrate further construction details of the battery case 134 and the battery case holder 136. More specifically, FIG. 4 is an exploded view illustrating some construction details of the battery case 134 and the battery case holder 136. FIG. 5 is a perspective view illustrating the battery case holder 136 fixedly attached to the end 108B of the rail 108. FIG. 6 is a perspective view illustrating the battery case holder 136 alone. FIG. 7 is a perspective view illustrating the battery case 134 alone. FIGS. 8 and 9 are two perspective views illustrating a housing 160 of the battery case 134. FIG. 10 is a partial cross-sectional view illustrating the placement of electric connectors 166 in the housing 160 of the battery case 134. FIG. 11 is a cross-sectional view illustrating the battery case 134 connected with the battery case holder 136.

Referring to FIGS. 1, 2, 4-6 and 11, the battery case holder 136 can be provided in the form of a plug fixedly attached to the end 108B of the rail 108. According to an example of construction, the rail 108 can have a bracket 138 for attaching the battery case holder 136. The bracket 138 can be formed as a unitary part having a base plate 140, two opposite arms 142 projecting from an upper side of the base plate 140, and a shoulder portion 144 projecting from the upper side of the base plate 140 and bridging the two arms 142.

The battery case holder 136 can include a coupling part 146, and a plurality of electric connectors 148 affixed to the coupling part 146 through which electric power can be supplied to the electric motor 124 and the motor controller 125. The coupling part 146 can be made of an electrically non-conductive material, which may include, without limitation, plastic materials. According to an example of construction, the coupling part 146 can have an opening 150 at one side, and a connecting portion 152 protruding at another side opposite to that of the opening 150. The coupling part 146 may have one or more peripheral surface that generally matches with an outer contour of the rail 108. The coupling part 146 including the connecting portion 152 may be formed integrally as a single part. The electric connectors 148 may be affixed to the connecting portion 152 of the coupling part 146. According to an example of construction, two electric connectors 148 can be provided, which can respectively include an anode and a cathode. According to an example of construction, the electric connectors 148 may include electrically conductive plates. The electric connectors 148 can be electrically connected with the motor controller 125 via a cable or a wiring.

For attaching the battery case holder 136 to the rail 108, the bracket 138 can be first fastened to the rail 108. For example, the bracket 138 can be disposed inside the cavity 110 of the rail 108 adjacent to the end 108B, and can be fixedly attached to the rail 108 via one or more fastener 154. The fastener 154 can engage with the base plate 140 of the bracket 138 and the rail 108 along an axis X1, which can be generally vertical when the rail 108 is affixed to a wall in a use configuration. Then the battery case holder 136 can be installed onto the rail 108 with the end 108B of the rail 108 and the arms 142 of the bracket 138 at least partially received inside the opening 150 of the coupling part 146. The battery case holder 136 can be fixedly attached to the bracket 138 via at least a fastener 156, which can engage with the battery case holder 136 and the shoulder portion 144 of the bracket 138 along an axis X2. For example, the coupling part 146 of the battery case holder 136 can be provided with a nut 158, and the fastener 156 can engage with the nut 158 for attaching the battery case holder 136 to the bracket 138. The axis X2 can extend generally parallel to the rail 108 from the end 108B to the end 108A thereof, and can be substantially orthogonal to the axis X1. The battery case holder 136 can be thereby securely attached to the rail 108 with the connecting portion 152 protruding outside the rail 108, and can sustain the battery case 134 in a stable manner without undesirable tilting relative to the rail 108.

Referring to FIGS. 4 and 7-11, the battery case 134 can include a housing 160, a lid 162, a plurality of electric conductors 164, and a plurality of electric connectors 166. The housing 160 can have an interior configured to receive one or more battery cells BA. According to an example of construction, the housing 160 may be sized to receive 8 battery cells BA. It will be appreciated, however, that the housing 160 may be configured to receive any number of battery cells BA according to the needs. One side of the housing 160 can have a slot 168 adapted to receive at least partially the connecting portion 152 of the battery case holder 136. For example, the slot 168 can be provided on an outer sidewall 170 of the housing 160.

The lid 162 can be positioned adjacent to the housing 160 for covering at least partially the interior of the housing 160 and the battery cells BA therein, and can be detached and moved away from the housing 160 for accessing to the interior of the housing 160. According to an example of construction, the housing 160 can have a plurality of openings 172 provided at a peripheral region of the outer sidewall 170, and the lid 162 may have a plurality of tabs 162A protruding from a side edge thereof that can respectively engage with the openings 172 on the outer sidewall 170 of the housing 160. The lid 162 may slide over the housing 160 until the tabs 162A respectively engage with the openings 172 for attaching the lid 162 to the housing 160.

The electric conductors 164 can be disposed in the interior of the housing 160 for electric contact with the battery cells BA. For example, the interior of the housing 160 can have two opposite inner sidewalls 160A and 160B, three electric conductors 164 spaced apart from one another may be affixed to the inner sidewall 160A, and two other electric conductors 164 spaced apart from each other may be affixed to the inner sidewall 160B. Two electric connectors 166 can be affixed to the housing 160 adjacent to the slot 168, and can be respectively connected electrically with two ones of the electric conductors 164 on the inner sidewall 160A of the housing 160. According to an example of construction, the electric connectors 166 may include electrically conductive plates. The electric connectors 166 of the battery case 134 are exposed for contact with the electric connectors 148 of the battery case holder 136. According to an example of construction, the electric connectors 166 may be positioned inside the slot 168 of the housing 160.

The battery case 134 is removable from the battery case holder 136 and the rail 108 for accessing to the interior of the battery case 134, and is connectable with the battery case holder 136 so that the electric connectors 148 of the battery case holder 136 respectively contact with the electric connectors 166 of the battery case 134 for supplying electric power from the battery cells BA to the electric motor 124 and the motor controller 125 installed in the cavity 110 of the rail 108. The removable battery case 134 provides a modular design, and can facilitate replacement of the battery cells BA.

For connecting the battery case 134 with the battery case holder 136, the battery case 134 can be moved in a direction from the front surface F of the rail 108 toward the rear surface R of the rail 108 with the connecting portion 152 of the coupling part 146 inserted into the slot 168 and in sliding contact with the housing 160 of the battery case 134. Once the connecting portion 152 is fully inserted into the slot 168, the electric connectors 148 of the battery case holder 136 can respectively contact with the electric connectors 166 of the battery case 134. Accordingly, electric power provided by the battery cells BA inside the battery case 134 can be supplied through the electric connectors 148 and 166 to the electric motor 124 and the motor controller 125 installed in the cavity 110 of the rail 108. Once the battery case 134 is installed onto the rail 108, the battery case 134 may protrude from the front surface F of the rail 108 so that the outer sidewall 170 of the housing 160 may be partially exposed outside the rail 108.

For detaching the battery case 134 from the battery case holder 136, the battery case 134 can be moved reversely until the connecting portion 152 of the coupling part 146 is fully disengaged from the slot 168 of the housing 160. The battery case 134 can be thereby removed from the battery case holder 136 and the rail 108, which disengages the electric connectors 166 of the battery case 134 from the electric connectors 148 of the battery case holder 136. Then the lid 162 can be detached from the housing 160, and new battery cells BA can be installed in the housing 160. Once the battery cells BA are installed in the housing 160, the lid 162 can be attached to the housing 160, and the battery case 134 can be connected with the battery case holder 136 as described previously.

When the battery case 134 is installed onto the rail 108, a latch may be provided to securely lock the battery case 134 in position relative to the battery case holder 136 and the rail 108, wherein the latch may be assembled with the battery case 134 or the battery case holder 136.

Referring to FIGS. 4 and 7-11, an embodiment may provide a latch 174 that is assembled with the battery case 134 for locking the battery case 134 in position when the battery case 134 is installed onto the rail 108. For example, the latch 174 can move relative to the battery case 134 to engage with the battery case holder 136 for locking the battery case 134 in position relative to the battery case holder 136 and the rail 108, or to disengage from the battery case holder 136 for unlocking the battery case 134 so that the battery case 134 is removable from the battery case holder 136 and the rail 108. According to an example of construction, the latch 174 can be pivotally connected with the battery case 134. For example, the latch 174 can be pivotally connected with the housing 160 of the battery case 134 via a pivot shaft 176. In this manner, the latch 174 can rotate relative to the battery case 134 for engaging with or disengaging from the battery case holder 136.

Referring to FIGS. 4-11, the coupling part 146 of the battery case holder 136 can have an anchoring portion 178 for receiving the engagement of the latch 174. The anchoring portion 178 may include, e.g., a protrusion having a barb adapted to engage with the latch 174. It will be appreciated, however, that the anchoring portion 178 may have any suitable structure and shape adapted to engage with the latch 174, which may include, without limitations, hooks, slots, openings, and the like. According to an example of construction, the latch 174 can be disposed adjacent to the slot 168 of the housing 160, and the anchoring portion 178 can be correspondingly disposed adjacent to the connecting portion 152 of the coupling part 146 at a side corresponding to the front surface F of the rail 108. This placement can have the latch 174 and the electric connectors 166 located at a same side of the battery case 134 adjacent to the slot 168 of the housing 160.

Referring to FIGS. 4 and 11, the latch 174 can be connected with a spring 180, which can bias the latch 174 to engage with the battery case holder 136 for locking the battery case 134 in position. According to an example of construction, the spring 180 may be a torsion spring. The spring 180 may have two ends respectively connected with the latch 174 and an inner sidewall of the housing 160.

Referring to FIGS. 4 and 7-11, the latch 174 can further have an actuating portion 182 exposed for operation. The actuating portion 182 is operable to cause the latch 174 to disengage from the battery case holder 136 for removal of the battery case 134. According to an example of construction, the actuating portion 182 may be fixedly connected with the latch 174, e.g., the latch 174 and the actuating portion 182 may be formed integrally as a single part. The actuating portion 182 may be exposed on the outer sidewall 170 of the housing 160, which can extend forward from the front surface F of the rail 108 when the battery case 134 is installed onto the rail 108. This placement can facilitate manual operation of the actuating portion 182.

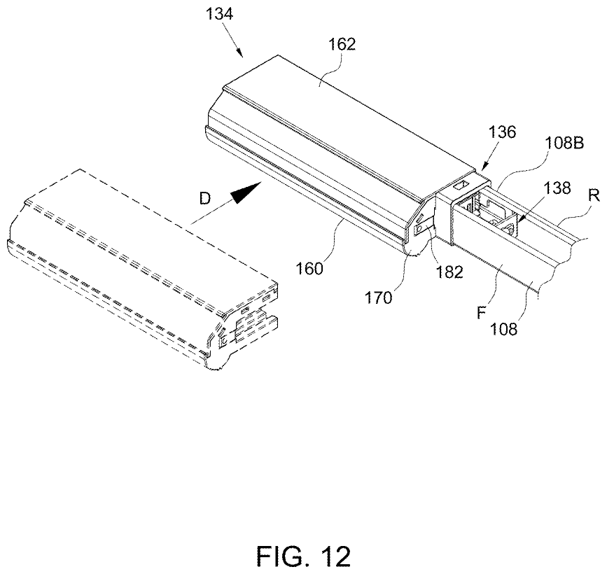

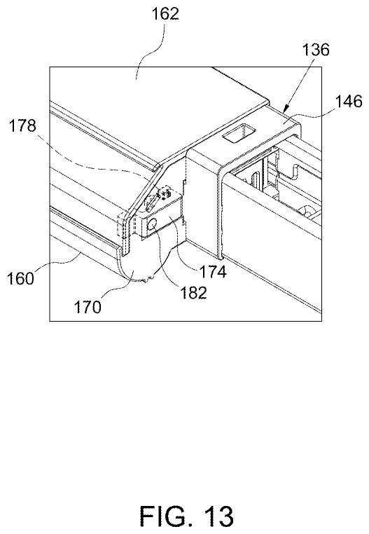

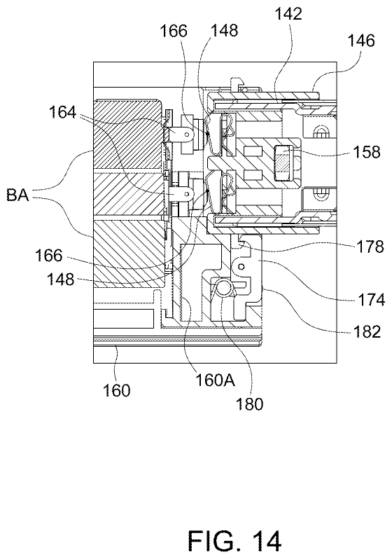

In conjunction with FIGS. 4-11, FIG. 12 is a schematic view illustrating exemplary operation for installing the battery case 134 onto the rail 108, FIG. 13 is an enlarged view of a portion of FIG. 12 illustrating the latch 174 engaged with the anchoring portion 178 when the battery case 134 is installed in position onto the rail 108, and FIG. 14 is a cross-sectional view illustrating the connection between the battery case 134 and the battery case holder 136. Referring to FIG. 12-14, for installing the battery case 134 onto the rail 108, the battery case 134 can be positioned so that the slot 168 of the housing 160 engages with the connecting portion 152 on the coupling part 146 of the battery case holder 136. Then the battery case 134 can slide in a direction D from the front surface F toward the rear surface R of the rail 108 in sliding contact with the connecting portion 152 until the electric connectors 148 of the battery case holder 136 respectively contact with the electric connectors 166 of the battery case 134 and the latch 174 engages with the anchoring portion 178, thereby locking the battery case 134 in position relative to the rail 108 and the battery case holder 136.

For removing the battery case 134 from the rail 108, the actuating portion 182 can be depressed so that the latch 174 disengages from the anchoring portion 178, thereby unlocking the battery case 134. Then the battery case 134 can be pulled away and removed from the rail 108.

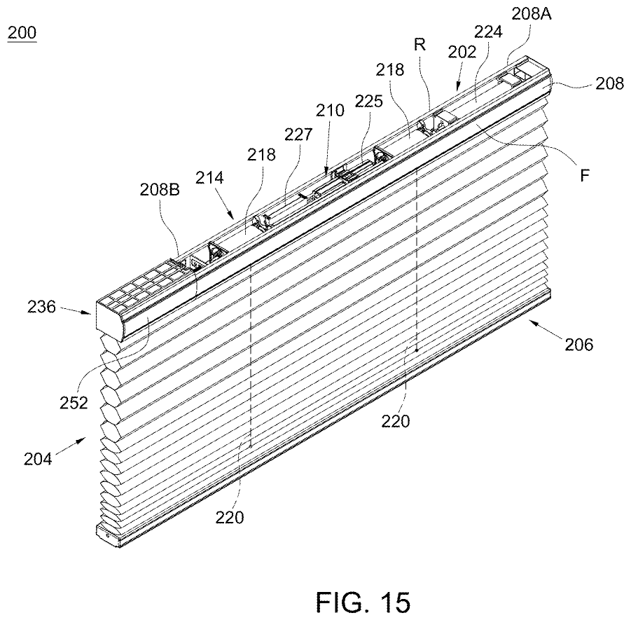

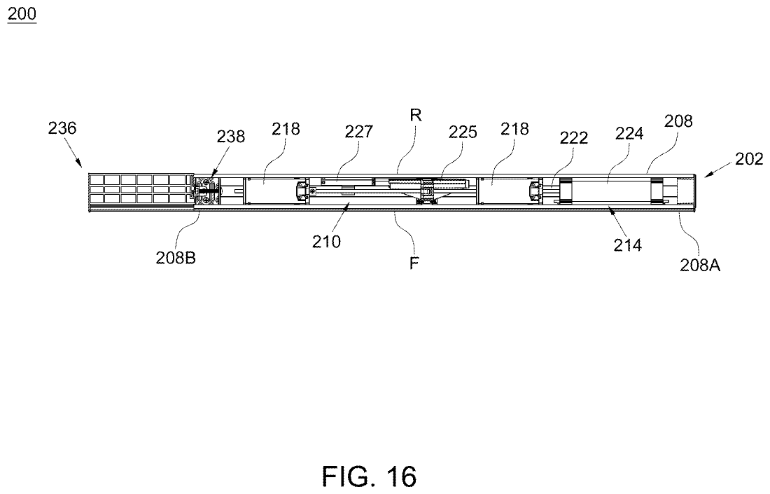

FIGS. 15 and 16 are respectively a perspective view and a top view illustrating another embodiment of an electrically-driven window shade 200. Referring to FIGS. 15 and 16, the electrically-driven window shade 200 can include a support structure 202, a shading structure 204 and a movable rail 206. The support structure 202 can include a rail 208 configured to provide support for the shading structure 204 and the movable rail 206. The rail 208 can be of an elongate shape provided with a cavity 210, and can have two opposite ends 208A and 208B, and a front surface F and a rear surface R opposite to each other. The cavity 210 may extend continuously from the end 208A to the end 208B of the rail 208, and may be delimited at least partially between the front surface F and the rear surface R of the rail 208. In a use configuration, the rail 208 can be affixed to a wall at a top of a window opening with the front surface F facing indoor, and the shading structure 204 and the movable rail 206 can be connected with the rail 208 so as to be suspended from the rail 208.

According to an example of construction, the shading structure 204 can include a honeycomb panel having two opposite ends respectively affixed to the movable rail 206 and the rail 208. The movable rail 206 can rise toward the rail 208 for retracting the shading structure 204, and lower for expanding the shading structure 204.

Referring to FIGS. 15 and 16, the electrically-driven window shade 200 can further include an actuating mechanism 214 operable to expand and retract the shading structure 204. The actuating mechanism 214 can include a plurality of winding units 218, suspension cords 220 respectively coupled to the winding units 218, a rotary axle 222, an electric motor 224 and a motor controller 225.

The winding units 218 can be disposed in the cavity 210 of the rail 208 at spaced-apart positions, and can be assembled coaxially about the rotary axle 222. The winding unit 218 may be similar to the winding unit 118 shown in FIG. 3, including a drum rotationally coupled to the rotary axle 222. The suspension cords 220 can pass through holes provided in the shading structure 204, each suspension cord 220 having an upper end connected with the drum of one corresponding winding unit 218 and a lower end connected with the movable rail 206. The movable rail 206 can be thereby suspended vertically below the rail 208. The rotary axle 222 can be assembled through the drums of the winding units 218, whereby the rotary axle 222 and the drums can rotate in unison.

The electric motor 224 can be disposed in the cavity 210 of the rail 208 adjacent to the end 208A of the rail 208, and can have an output rotationally coupled to the rotary axle 222. According to an example of construction, the electric motor 224 can be a DC motor. The electric motor 224 is coupled to the motor controller 225, and is operable to drive the rotary axle 222 in rotation for expanding the shading structure 204 away from the rail 208 or retracting the shading structure 204 toward the rail 208 via a displacement of the movable rail 206.

According to an embodiment, the motor controller 225 may be coupled to a wireless adapter 227 for providing wireless control. The wireless adapter 227 can receive a wireless signal (e.g., infrared (IR) or radio-frequency (RF) signal) emitted from a remote controller (not shown), convert the wireless signal to an electric signal, and transmit the electric signal to the motor controller 225.

According to another embodiment, the wireless adapter 227 may be omitted, and the motor controller 225 may be instead coupled to a control interface provided at an end of a hollow wand, like in the previous embodiment illustrated in FIG. 1.

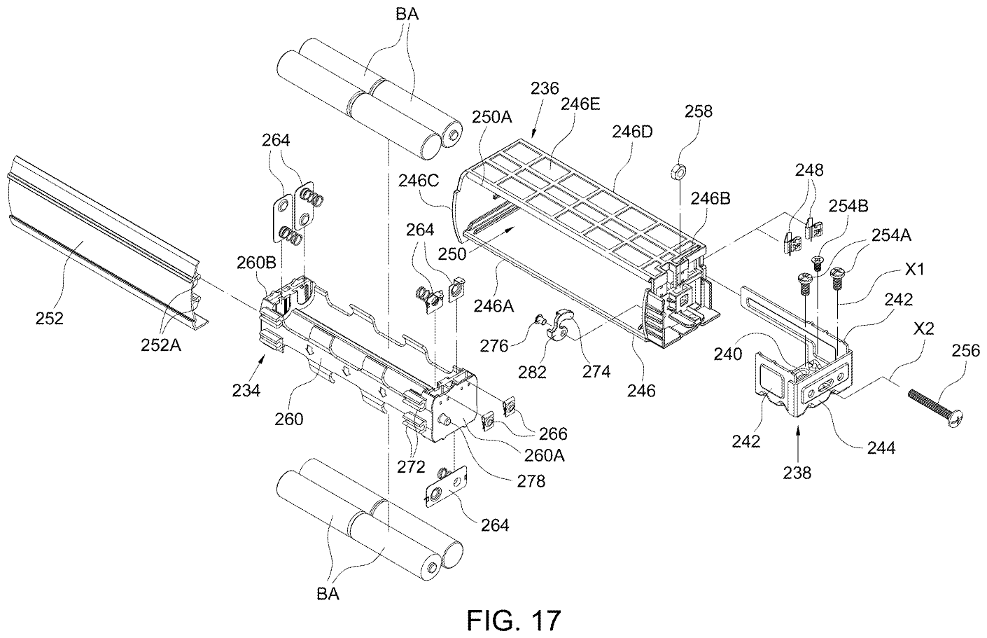

Referring to FIGS. 15 and 16, the support structure 202 can further include a battery case 234 (better shown in FIG. 17) having an interior configured to receive one or more battery cells BA for supplying electric power to the electric motor 224 and the motor controller 225 installed in the rail 208. The battery case 234 is detachably connected with the rail 208. For example, the rail 208 is fixedly connected with a battery case holder 236, and the battery case 234 can be connected with and removed from the battery case holder 236 as desired. The battery case holder 236 can be provided at the end 208B of the rail 208, and the battery case 234 can be connected with the battery case holder 236 outside the rail 208.

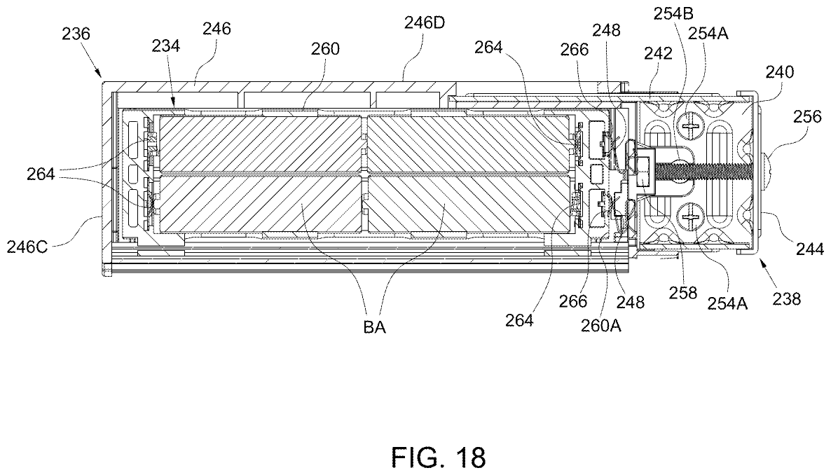

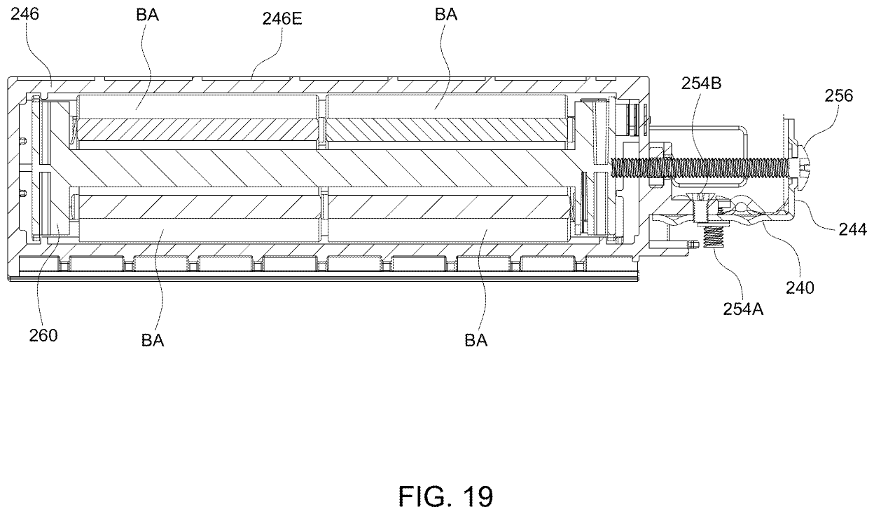

In conjunction with FIGS. 15 and 16, FIG. 17 is an exploded view illustrating some construction details of the battery case 234 and the battery case holder 236, FIG. 18 is a partial cross-sectional view illustrating the battery case 234 and the battery case holder 236 connected with each other, and FIG. 19 is a partial cross-sectional view taken along a sectional plane perpendicular to that of FIG. 18. Referring to FIGS. 15-19, the battery case holder 236 can be provided in the form of a box fixedly attached to the end 208B of the rail 208. According to an example of construction, the rail 208 can have a bracket 238 for attaching the battery case holder 236. The bracket 238 can be formed as a unitary part having a base plate 240, two opposite arms 242 projecting from an upper side of the base plate 240, and a shoulder portion 244 projecting from the upper side of the base plate 240 and bridging the two arms 242.

The battery case holder 236 can include a casing 246, and a plurality of electric connectors 248 through which electric power can be supplied to the electric motor 224 and the motor controller 225. The casing 246 can be made of an electrically non-conductive material, which may include, without limitation, plastic materials. The casing 246 can have a bottom plate 246A, a plurality of sidewalls 246B, 246C and 246D projecting from an upper side of the bottom plate 246A, and a top plate 246E opposite to the bottom plate 246A that is connected with the sidewalls 246B, 246C and 246D. The bottom plate 246A, the sidewalls 246B, 246C and 246D and the top plate 246E can at least partially define a cavity 250 adapted to receive the battery case 234. The battery case 234 can be inserted into the cavity 250 via an opening 250A, which can be provided on a side of the casing 246 corresponding to the front surface F of the rail 208. A cover 252 can be provided to close and uncover the opening 250A of the casing 246 as desired. According to an example of construction, the cover 252 is positionable adjacent to the casing 246 to close the opening 250A, and detachable and movable away from the casing 246 to uncover the opening 250A.

The electric connectors 248 can be affixed to the sidewall 246B of the casing 246, and can be exposed inside the cavity 250 of the casing 246. According to an example of construction, two electric connectors 248 can be provided, which can respectively include an anode and a cathode. The electric connectors 248 can be electrically connected with the motor controller 225 via a cable or a wiring.

For attaching the battery case holder 236 to the rail 208, the bracket 238 is first fastened to the rail 208. For example, the bracket 238 can be disposed inside the cavity 210 of the rail 208 adjacent to the end 208B thereof, and can be fixedly attached to the rail 208 via one or more fastener 254A. The fastener 254A can engage with the base plate 240 of the bracket 238 and the rail 208 along an axis X1, which can be generally vertical when the rail 208 is affixed to a wall in a use configuration. The battery case holder 236 can be installed onto the rail 208 with the end 208B of the rail 208 and the arms 242 of the bracket 238 disposed adjacent to the sidewall 246B of the casing 246. For example, one or more of the arms 242 of the bracket 238 may be inserted into corresponding slits provided in the casing 246. The battery case holder 236 can be fixedly attached to the bracket 238 via at least a fastener 256, which can engage with the battery case holder 236 and the shoulder portion 244 of the bracket 238 along an axis X2. For example, the sidewall 246B of the casing 246 can be provided with a nut 258, and the fastener 256 can engage with the nut 258 for attaching the battery case holder 236 to the bracket 238. The axis X2 can extend generally parallel to the rail 208 from the end 208B to the end 208A thereof, and can be substantially orthogonal to the axis X1. Moreover, the battery case holder 236 may be fixedly attached to the bracket 238 via a fastener 254B, which can engage the battery case holder 236 and the base plate 240 parallel to the axis X1. For example, the casing 246 can have a tongue 246F protruding from the sidewall 246B above the base plate 240, and the fastener 254B can engage through the tongue 246F with the base plate 240. The battery case holder 236 can be thereby securely attached to the rail 208 with the opening 250A of the casing 246 oriented in the same direction as the front surface F of the rail 208.

Referring to FIGS. 15-19, the battery case 234 can include a housing 260, a plurality of electric conductors 264, and a plurality of electric connectors 266. The housing 260 can have an interior configured to receive one or more battery cells BA. According to an example of construction, the housing 260 may be sized to receive 8 battery cells BA. It will be appreciated, however, that the housing 260 may be configured to receive any number of battery cells BA according to the needs.

The electric conductors 264 can be disposed in the interior of the housing 260 for electric contact with the battery cells BA. For example, the housing 260 can have two opposite sidewalls 260A and 260B, three electric conductors 264 spaced apart from one another may be affixed to the sidewall 260A, and two other electric conductors 264 spaced apart from each other may be affixed to the sidewall 260B. Two electric connectors 266 can be affixed to the housing 260 adjacent to the sidewall 260A, and can be respectively connected electrically with two ones of the electric conductors 264 affixed to the sidewall 260A of the housing 260. According to an example of construction, the electric connectors 266 may include electrically conductive plates. The electric connectors 266 of the battery case 234 are exposed on an outer side of the sidewall 260A for contact with the electric connectors 248 of the battery case holder 236.

Like previously described, the battery case 234 is removable from the battery case holder 236 and the rail 208 for accessing to the interior of the battery case 234, and is connectable with the battery case holder 236 so that the electric connectors 248 of the battery case holder 236 respectively contact with the electric connectors 266 of the battery case 234 for supplying electric power from the battery cells BA to the electric motor 224 and the motor controller 225 installed in the cavity 210 of the rail 208.

For connecting the battery case 234 with the battery case holder 236, the cover 252 can be detached from the casing 246 of the battery case holder 236, and the battery case 234 can be inserted via the opening 250A into the cavity 250 of the casing 246. Once the battery case 234 is fully inserted into the cavity 250, the electric connectors 248 of the battery case holder 236 can respectively contact with the electric connectors 266 of the battery case 234. Electric power provided by the battery cells BA inside the battery case 234 can thus be supplied through the electric connectors 248 and 266 to the electric motor 224 and the motor controller 225 installed in the cavity 210 of the rail 208. Once the battery case 234 is installed in the cavity 250 of the casing 246, the cover 252 can be positioned adjacent to the casing 246 to close the opening 250A. According to an example of construction, the cover 252 can attach to the battery case 234 installed inside the casing 246 of the battery case holder 236 when it closes the opening 250A of the casing 246. For example, the housing 260 of the battery case 234 can have one or more notch 272, and the cover 252 can have one or more protruding rib 252A that can respectively engage with the notch 272 when the cover 252 is positioned to close the opening 250A of the casing 246. The battery case 234 can be thereby enclosed and concealed inside the battery case holder 236.

For detaching the battery case 234 from the battery case holder 236, the cover 252 can be detached from the battery case 234 and the casing 246, and the battery case 234 then can be removed from the battery case holder 236 and the rail 208, which disengages the electric connectors 266 of the battery case 234 from the electric connectors 248 of the battery case holder 236. Once the battery cells BA are installed in the housing 260, the battery case 234 can be installed onto the rail 208 as described previously.

When the battery case 234 is installed onto the rail 208, a latch may be provided to securely lock the battery case 234 in position relative to the battery case holder 236 and the rail 208, wherein the latch may be assembled with the battery case 234 or the battery case holder 236.

Referring to FIGS. 17 and 18, an embodiment may provide a latch 274 that is assembled with the battery case holder 236 for locking the battery case 234 in position when the battery case 234 is installed onto the rail 208. For example, the latch 274 can move relative to the battery case holder 236 to engage with the battery case 234 for locking the battery case 234 in position relative to the battery case holder 236 and the rail 208, or to disengage from the battery case 234 so that the battery case 234 is unlocked and can be removed from the battery case holder 236 and the rail 208. According to an example of construction, the latch 274 can be pivotally connected with the battery case holder 236. For example, the latch 274 can be disposed inside the cavity 250 of the casing 246, and can be pivotally connected with the sidewall 246B of the casing 246 via a pivot shaft 276. In this manner, the latch 274 can rotate relative to the battery case holder 236 for engaging with and disengaging from the battery case 234.

Referring to FIG. 17, the battery case 234 can have an anchoring portion 278 for receiving the engagement of the latch 274. The anchoring portion 278 may include, e.g., a protrusion provided on the housing 260 of the battery case 234 that is adapted to engage with the latch 274. According to an example of construction, the latch 274 can be disposed adjacent to the sidewall 246B of the casing 246 of the battery case holder 236, and the anchoring portion 278 can correspondingly protrude from the sidewall 260A of the housing 260. This placement can have the latch 274 and the electric connectors 266 located at a same side of the battery case 234. When the battery case 234 is positioned inside the casing 246 of the battery case holder 236, the latch 274 can move relative to the battery case holder 236 to engage with the anchoring portion 278 for locking the battery case 234 to the battery case holder 236, or to disengage from the anchoring portion 278 for unlocking the battery case 234 so that the battery case 234 is removable from the battery case holder 236.

Referring to FIG. 17, the latch 274 can further have an actuating portion 282 operable to cause the latch 274 to disengage from the battery case 234 for removal of the battery case 234. According to an example of construction, the actuating portion 282 may be fixedly connected with the latch 274, e.g., the latch 274 and the actuating portion 282 may be formed integrally as a single part. The actuating portion 282 may have any suitable shape for facilitating its manual operation. The actuating portion 282 can be concealed inside the cavity 250 of the casing 246 and inaccessible when the cover 252 closes the opening 250A of the casing 246, and exposed for operation when the opening 250A of the casing 246 is uncovered.

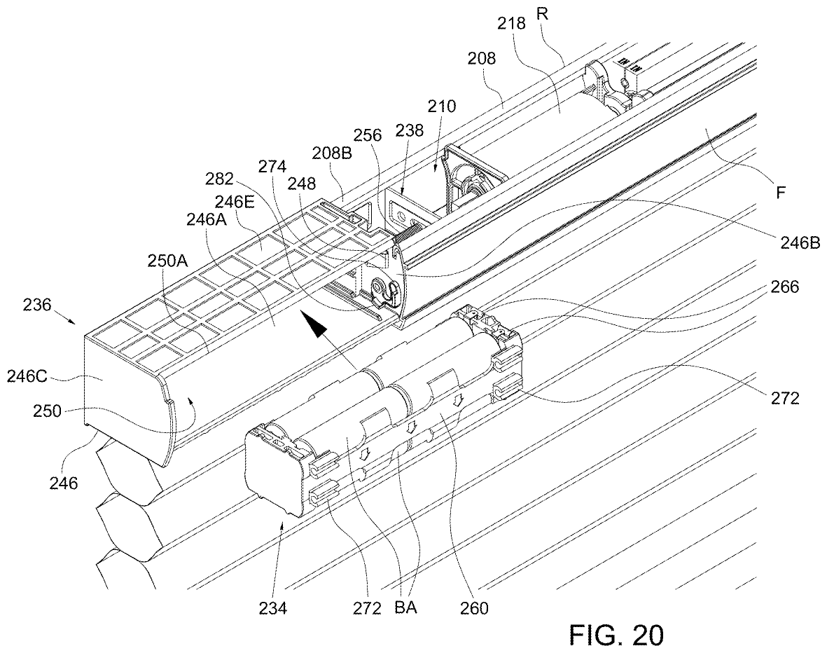

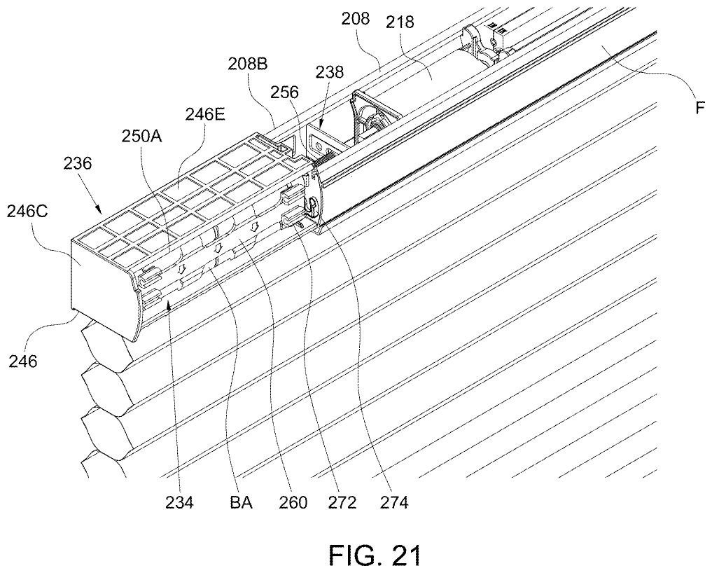

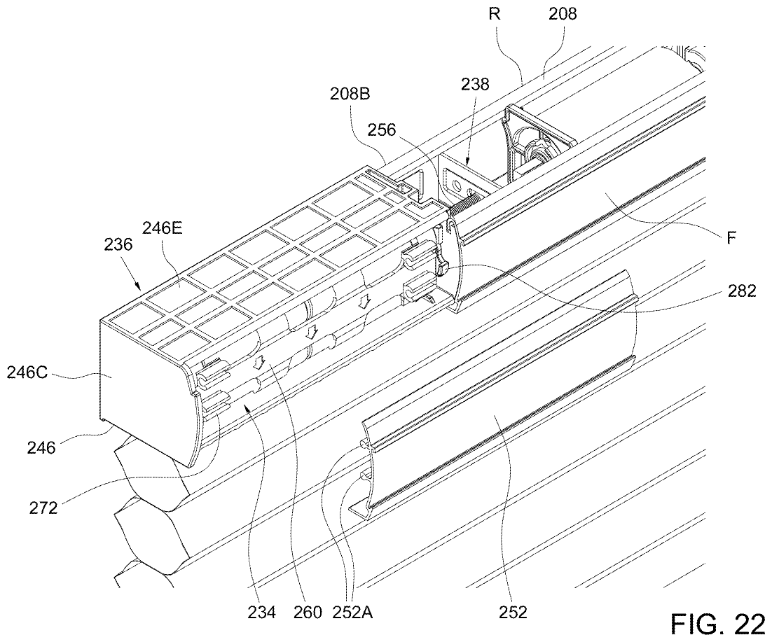

In conjunction with FIGS. 15-19, FIGS. 20-22 are schematic views illustrating exemplary operation for installing the battery case 234 onto the rail 208. Referring to FIG. 17-22, for installing the battery case 234 onto the rail 208, the battery case 234 is moved in a direction from the front surface F toward the rear surface R of the rail 208 for insertion through the opening 250A into the cavity 250 of the casing 246 until the electric connectors 248 of the battery case holder 236 respectively contact with the electric connectors 266 of the battery case 234. Once the battery case 234 is properly positioned inside the casing 246, the latch 274 is rotated in one direction relative to the battery case holder 236 to engage with the anchoring portion 278, thereby locking the battery case 234 in position relative to the rail 208 and the battery case holder 236. Then the cover 252 is positioned adjacent to the casing 246 to close the opening 250A.

For removing the battery case 234 from the rail 208, the cover 252 is first detached and moved away from the casing 246 of the battery case holder 236 to uncover the opening 250A, which can expose the actuating portion 282 for operation. The rib 252A of the cover 252 can disengage from the notch 272 on the housing 260 of the battery case 234 as the cover 252 is moved away from the battery case holder 236. The actuating portion 282 is rotated in a reverse direction so that the latch 274 disengages from the anchoring portion 278, thereby unlocking the battery case 234 from the battery case holder 236. Then the battery case 234 can be pulled out of the casing 246 and removed from the rail 208.

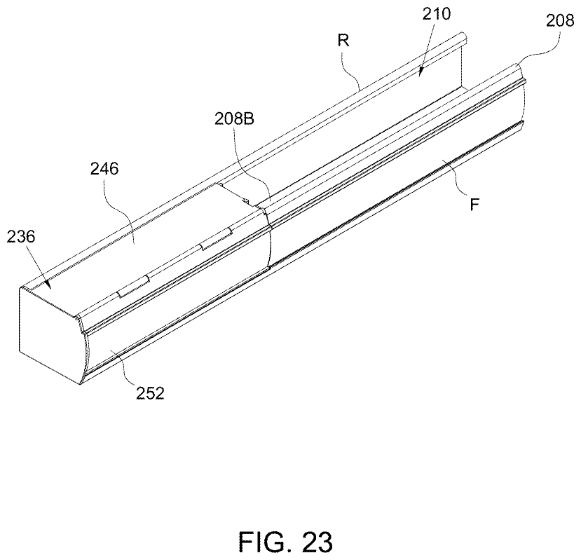

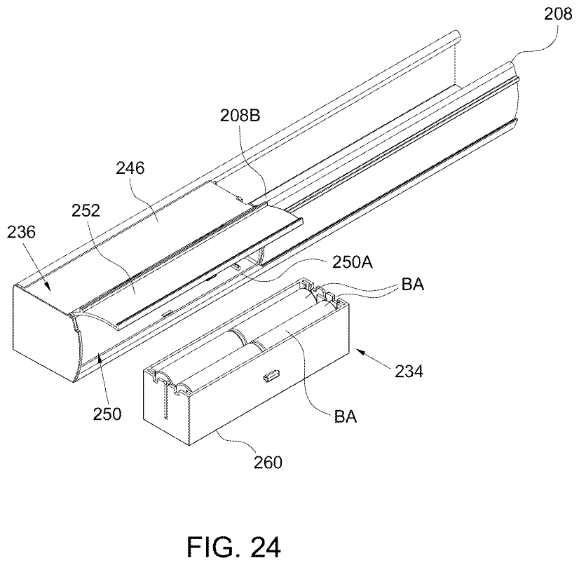

FIGS. 23 and 24 are perspective views illustrating a variant construction in which the cover 252 can be pivotally attached to the casing 246 of the battery case holder 236. Referring to FIGS. 23 and 24, the cover 252 can rotate in one direction relative to the casing 246 to close the opening 250A, and rotate in an opposite direction relative to the casing 246 to uncover the opening 250A for removal or installation of the battery case 234.

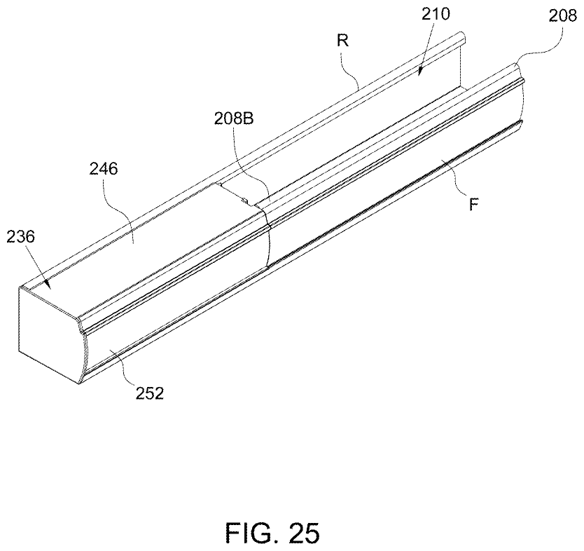

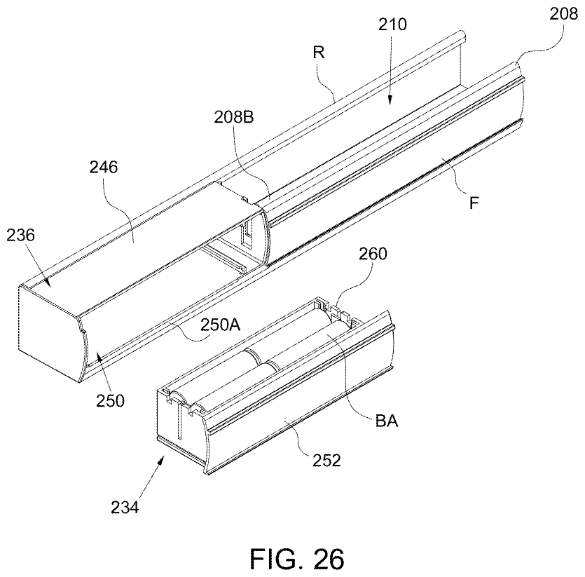

FIGS. 25 and 26 are perspective views illustrating another variant construction in which the cover 252 is fixedly connected with the battery case 234. For example, the cover 252 can be fixedly attached to the housing 260 of the battery case 234. The opening 250A of the casing 246 of the battery case holder 236 can be closed with the cover 252 when the battery case 234 is disposed inside the cavity 250 of the casing 246, and can be uncovered when the battery case 234 is removed from the casing 246.

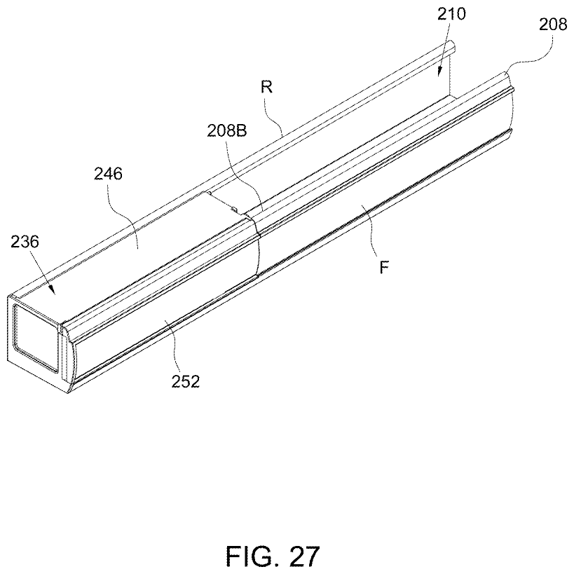

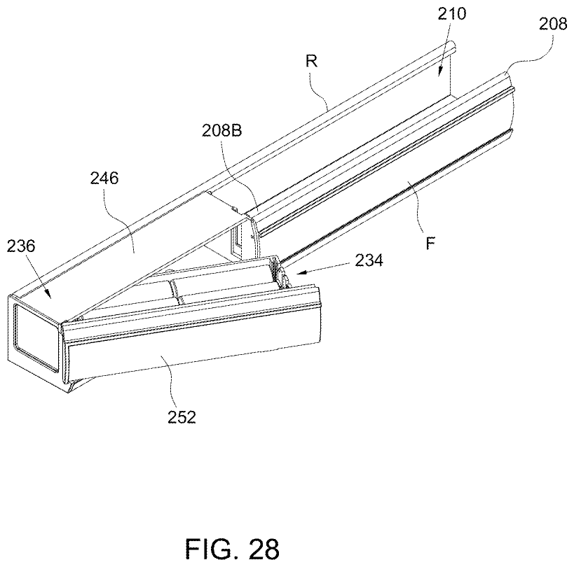

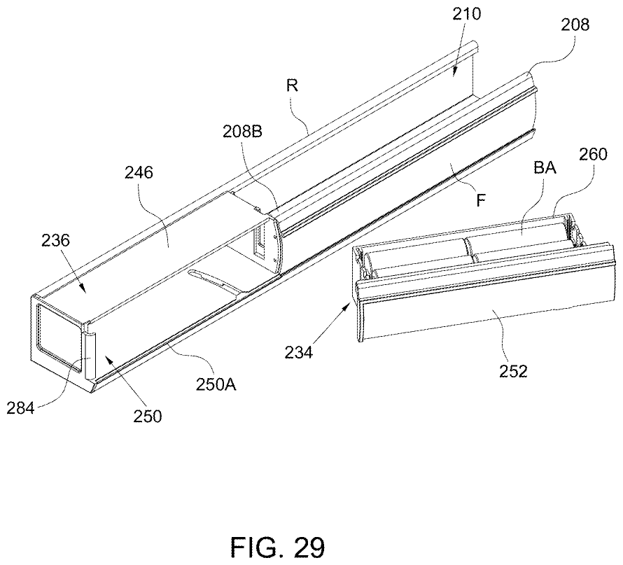

FIGS. 27-29 are perspective views illustrating another variant construction in which the cover 252 is fixedly connected with the battery case 234, and the casing 246 of the battery case holder 236 can include a pivot support portion 284 connectable with the battery case 234. Referring to FIGS. 27-29, when the battery case 234 is installed inside the casing 246 of the battery case holder 236, the pivot support portion 284 can be engaged with the housing 260 of the battery case 234, and the cover 252 can close the opening 250A of the casing 246. While the housing 260 is in contact with the pivot support portion 284, the battery case 234 can be rotated about the pivot support portion 284 relative to the battery case holder 236 toward the outside of the casing 246 for removing the battery case 234 from the battery case holder 236.

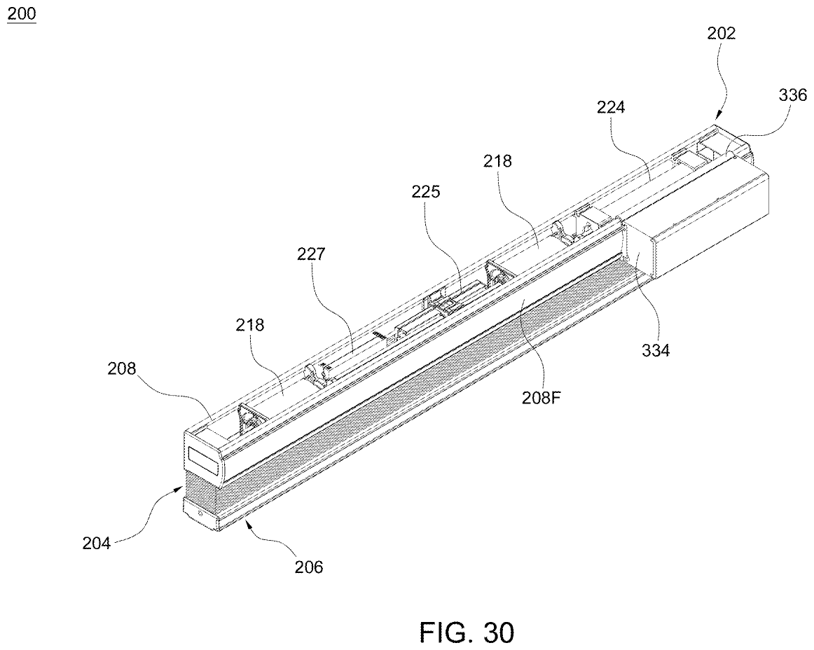

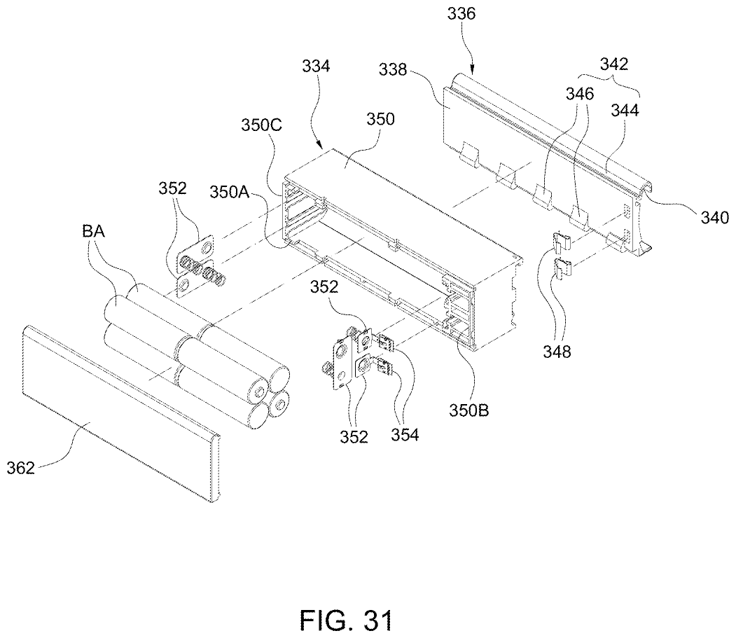

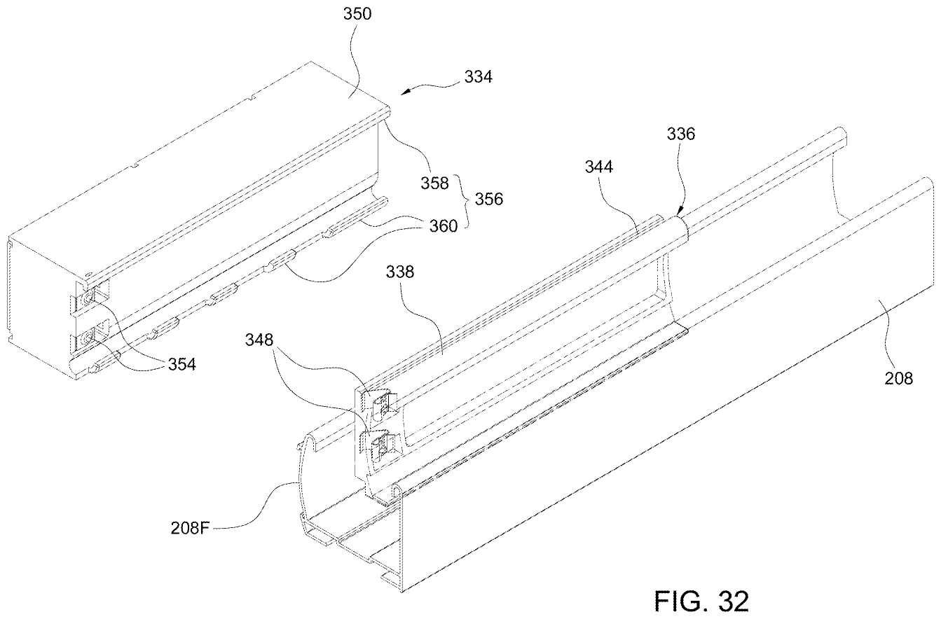

FIGS. 30-32 are schematic views illustrating another construction of a battery case 334 and a battery case holder 336 that may be provided in the support structure 202 of the window shade 200. Referring to FIGS. 30-32, the battery case 334 has an interior configured to receive one or more battery cells BA for supplying electric power to the electric motor 224 and the motor controller 225. The rail 208 is connected with the battery case holder 336, and the battery case 334 can be connected with and removed from the battery case holder 336 as desired. The battery case holder 336 can be provided on a front face 208F of the rail 208 (i.e., facing the interior of a room), and the battery case 334 can be connected with the battery case holder 336 outside the rail 208.

Referring to FIGS. 30-32, the battery case holder 336 can be provided in the form of a bracket 338 that is installable on and removable from the front face 208F of the rail 208. The bracket 338 can have a guide slot 340 for facilitating installation of the battery case holder 336 on the rail 208, and a coupling structure 342 for detachable connection of the battery case 334 with the battery case holder 336. The coupling structure 342 can include a groove 344 extending along an upper portion of the bracket 338, and a plurality of flanges 346 protruding from a lower portion of the bracket 338. Moreover, the battery case holder 336 can include a plurality of electric connectors 348 that are affixed to the bracket 338, and can be exposed at a front of the bracket 338. The electric connectors 348 can be electrically connected with the motor controller 225 via a cable or a wiring (not shown).

Referring to FIGS. 30-32, the battery case 334 can include a housing 350, a plurality of electric conductors 352, and a plurality of electric connectors 354. The housing 350 can have an interior configured to receive one or more battery cells BA, the interior of the housing 350 being accessible via an opening 350A provided at a front of the housing 350. Moreover, the housing 350 can have a coupling structure 356 provided at a rear thereof that is adapted to engage with the coupling structure 342 of the battery case holder 336. According to an example of construction, the coupling structure 356 can include a flange 358 extending along an upper portion of the housing 350, and a plurality of catches 360 protruding from a lower portion of the housing 350, the flange 358 and the catches 360 being provided at the rear of the housing 350.

The electric conductors 352 can be disposed in the interior of the housing 350 for electric contact with the battery cells BA. For example, the housing 350 can have two opposite sidewalls 350B and 350C, three electric conductors 352 spaced apart from one another may be affixed to the sidewall 350B, and two other electric conductors 352 spaced apart from each other may be affixed to the sidewall 350C. Two electric connectors 354 can be affixed to the housing 350 adjacent to the sidewall 350B, and can be respectively connected electrically with two ones of the electric conductors 352 affixed to the sidewall 350B of the housing 350. Moreover, the electric connectors 354 of the battery case 334 are exposed at the rear of the housing 350 for contact with the electric connectors 348 of the battery case holder 336.

Referring to FIGS. 30-32, a cover 362 can be provided to close and open the housing 350 of the battery case 334 as desired. For example, the cover 362 is positionable adjacent to the housing 350 to close the opening 350A thereof, and detachable and movable away from the housing 350 to uncover the opening 350A for placement or removal of the battery cells BA.

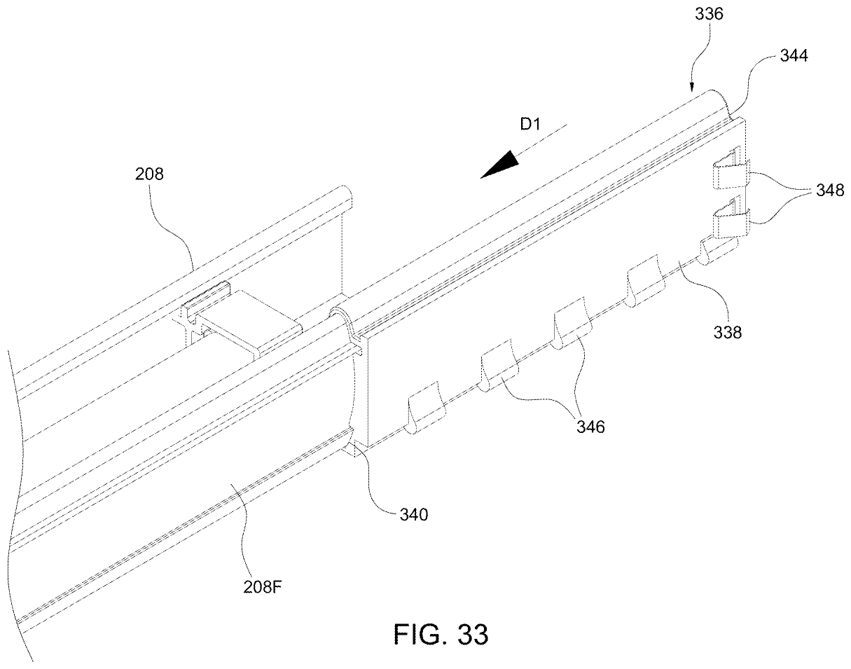

In conjunction with FIGS. 30-32, FIGS. 33-35 are schematic views illustrating exemplary operation for installing the battery case 334 and the battery case holder 336 on the rail 208. Referring to FIG. 33, the battery case holder 336 is first installed on the rail 208. For example, an end of the rail 208 can be inserted into the guide slot 340 of the bracket 338, and the battery case holder 336 can slide along the front face 208F of the rail 208 in a direction D1 until the battery case holder 336 is positioned properly. For example, the battery case holder 336 may be positioned at a location adjacent to the position of the electric motor 224.

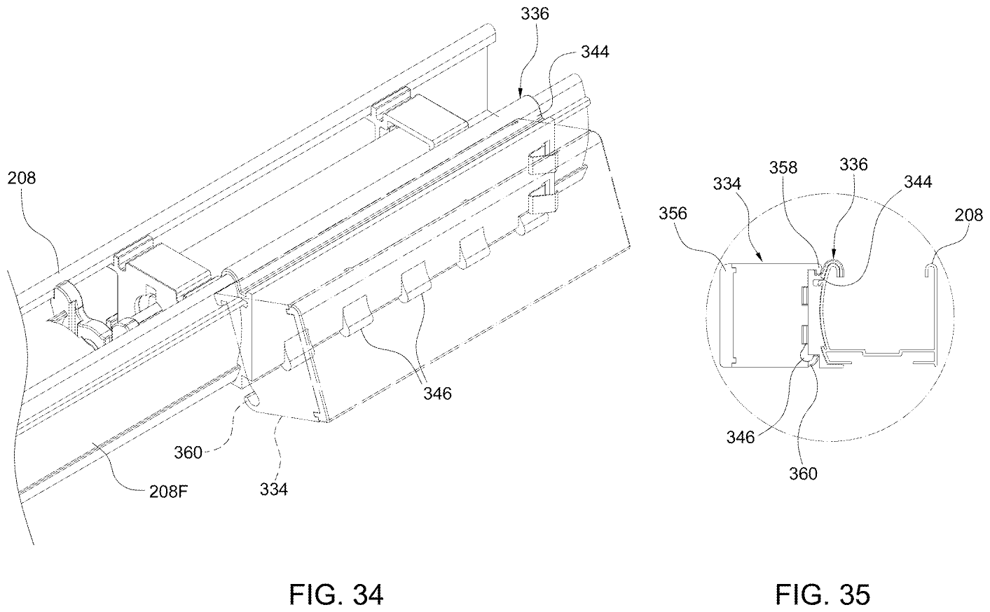

Referring to FIGS. 34 and 35, the battery case 334 can be positioned so that the flange 358 of the housing 350 is engaged with the groove 344 on the bracket 338 of the battery case holder 336. While the flange 358 remains engaged with the groove 344, the battery case 334 then can be rotated until the catches 360 of the battery case 334 respectively engage with the flanges 346 of the bracket 338 and the electric connectors 354 of the battery case 334 respectively contact with the electric connectors 348 of the battery case holder 336. For removing the battery case 334 from the battery case holder 336, a user can reversely rotate the battery case 334 for disengaging the catches 360 of the battery case 334 from the flanges 346 of the bracket 338.

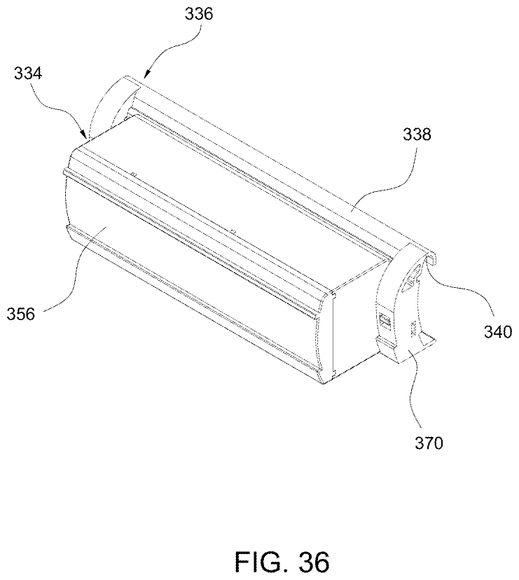

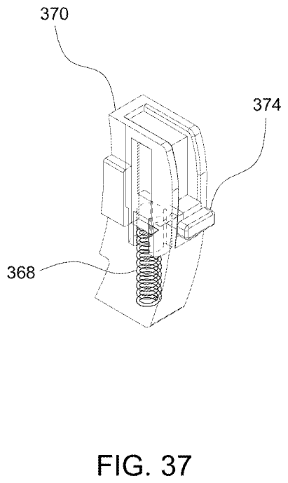

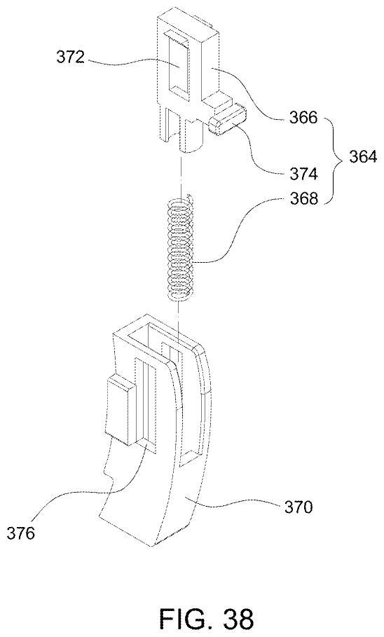

FIGS. 36-40 are schematic views illustrating a variant construction in which the battery case holder 336 can further include a latch mechanism 364 can be provided for locking the battery case 334 in position. Referring to FIGS. 36-40, the bracket 338 of the battery case holder 336 is adapted to be installed on the front face 208F of the rail 208 like previously described, and the latch mechanism 364 carried with the battery case holder 336 can include a latch 366 and a spring 368 assembled with the bracket 338. For example, the bracket 338 can have a sidewall 370 protruding at the front thereof, and the latch 366 and the spring 368 can be assembled adjacent to the sidewall 370. The sidewall 370 is located adjacent to an end of the battery case 334 when the battery case 334 is installed on the bracket 338 of the battery case holder 336. The latch 366 is movably connected with the bracket 338 for movement between a locking position and an unlocking position. According to an example of construction, the latch 366 can have an opening 372 and an actuating portion 374, and can be slidably assembled with the bracket 338 with the actuating portion 374 exposed on the sidewall 370 for operation. The spring 368 can have two ends respectively connected with the latch 366 and the bracket 338, and can bias the latch 366 toward the locking position. The actuating portion 374 is operable to urge the latch 366 to move against the biasing force of the spring 368 from the locking position to the unlocking position.

Referring to FIGS. 36-40, the latch 366 can engage with an anchoring portion 378 provided on the battery case 334 for locking the battery case 334 in position with respect to the battery case holder 336, wherein the anchoring portion 378 can be exemplarily connected with the housing 350 of the battery case 334 and protrude from a side end of the housing 350. For example, the battery case 334 can slide in a direction T1 (better shown in FIG. 39) for engaging a hook-shaped end of the anchoring portion 378 with the opening 372 of the latch 366. The biasing force of the spring 368 can keep the latch 366 in the locking position engaged with the anchoring portion 378 of the battery case 334. The latch 366 can thereby lock the battery case 334 to the battery case holder 336, and prevent horizontal sliding of the battery case 334 relative to the battery case holder 336.

For removing the battery case 334, a user can operate the actuating portion 374 to urge the latch 366 to move from the locking position to the unlocking position for disengaging from the anchoring portion 378. The battery case 334 is thereby unlocked, and can slide relative to the battery case holder 336 in a direction T2 (better shown in FIG. 40) opposite to the direction T1 for removal.

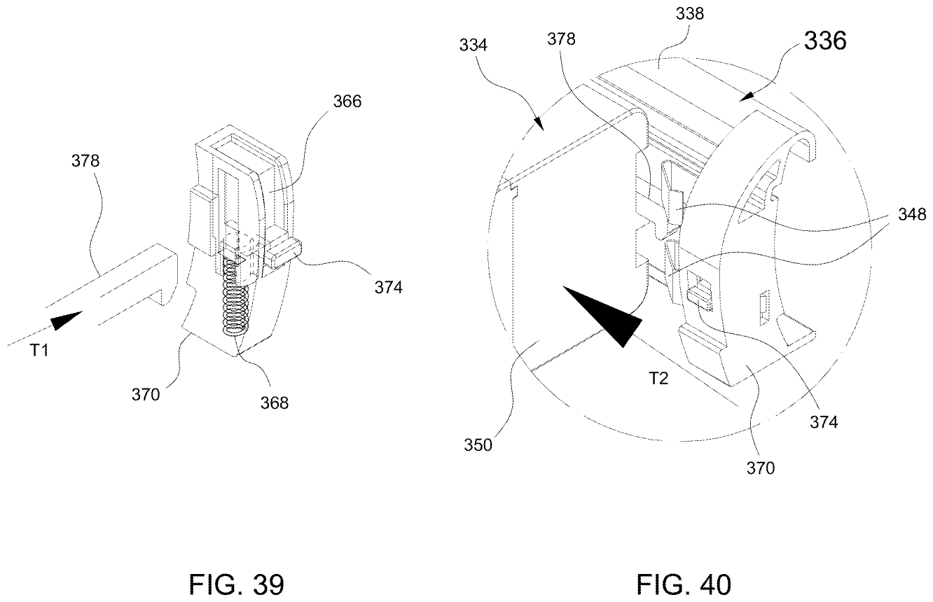

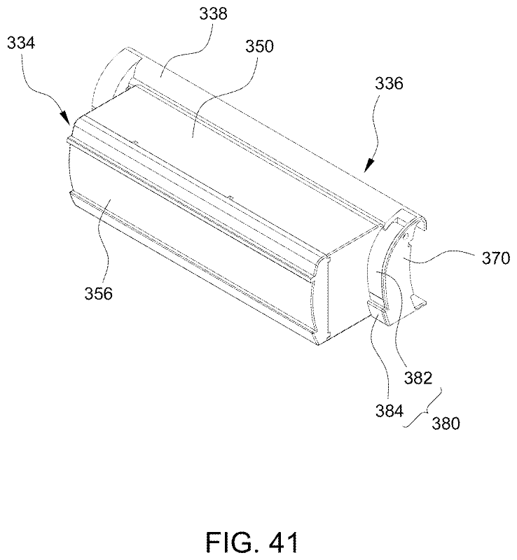

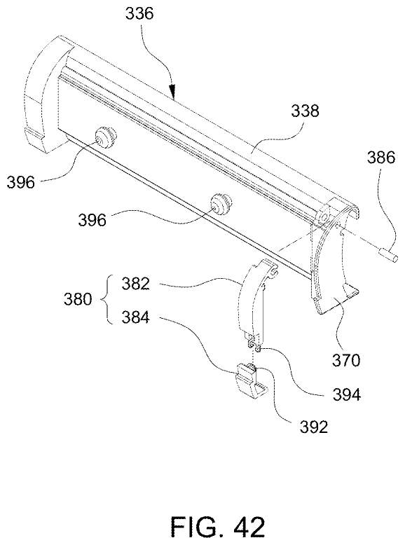

FIGS. 41-44 are schematic views illustrating a variant construction of a latch mechanism 380 provided on the battery case holder 336 for locking the battery case 334 in position. Referring to FIGS. 41-44, the bracket 338 of the battery case holder 336 is adapted to be installed on the front face 208F of the rail 208 like previously described, and the latch mechanism 380 can be disposed adjacent to the sidewall 370 of the bracket 338 and include a clamping part 382 and a latch 384. The clamping part 382 can be disposed adjacent to the sidewall 370 of the bracket 338, and can be pivotally connected with the bracket 338 via a shaft 386. The clamping part 382 is thereby rotatable relative to the bracket 338 between a retaining position shown in FIG. 41 and a release position shown in FIG. 44, the clamping part 382 being adjacent to a surface 388 of the bracket 338 in the retaining position and displaced away from the surface 388 in the release position.

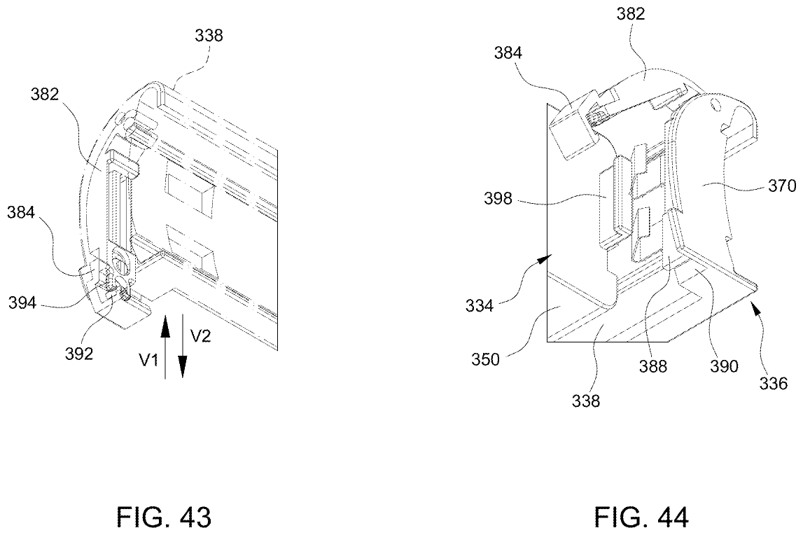

The latch 384 is movably connected with the clamping part 382, and is operable to lock the clamping part 382 in the retaining position. For example, the latch 384 can engage with a groove 390 provided on the bracket 338 for locking the clamping part 382 in the retaining position, and can disengage from the groove 390 for rotation of the clamping part 382 between the retaining position and the release position. According to an example of construction, the latch 384 is slidably connected with the clamping part 382 and has a knob 392, and the clamping part 382 has a catching portion 394 adapted to engage and disengage the knob 392. The catching portion 394 can exemplarily include two resilient arms movable to engage and disengage the knob 392. While the clamping part 382 is in the retaining position, the latch 384 can slide relative to the clamping part 382 in a direction V1 (better shown in FIG. 43) to engage with the groove 390 of the bracket 338 and bring the knob 392 into engagement with the catching portion 394. The engagement of the knob 392 with the catching portion 394 can assist in keeping the latch 384 engaged with the groove 390 of the bracket 338. Moreover, the latch 384 can slide relative to the clamping part 382 in a direction V2 (better shown in FIG. 43) opposite to the direction V1 to disengage with the groove 390 of the bracket 338 and cause the knob 392 to disengage from the catching portion 394.

In conjunction with FIGS. 41-44, FIGS. 45 and 46 are schematic views illustrating exemplary operation of the latch mechanism 380. Referring to FIG. 41, the battery case 334 is installed on the bracket 338 of the battery case holder 336, the clamping part 382 is in the retaining position, and the latch 384 is engaged with the groove 390 (better shown in FIG. 44) of the bracket 338 for locking the clamping part 382 in the retaining position. According to an example of construction, the bracket 338 can include a plurality of protrusions 396 that can engage with corresponding openings (not shown) provided on the housing 350 of the battery case 334 for assisting in positioning the battery case 334 on the bracket 338. In the retaining position, the clamping part 382 can engage with an anchoring portion 398 (better shown in FIG. 44) connected with the housing 350 of the battery case 334, whereby the anchoring portion 398 is held between the clamping part 382 and the surface 388 of the bracket 338. According to an example of construction, the anchoring portion 398 may be formed as a tab protruding from an end of the housing 350 of the battery case 334. The battery case 334 can be thereby locked in position with respect to the battery case holder 336.

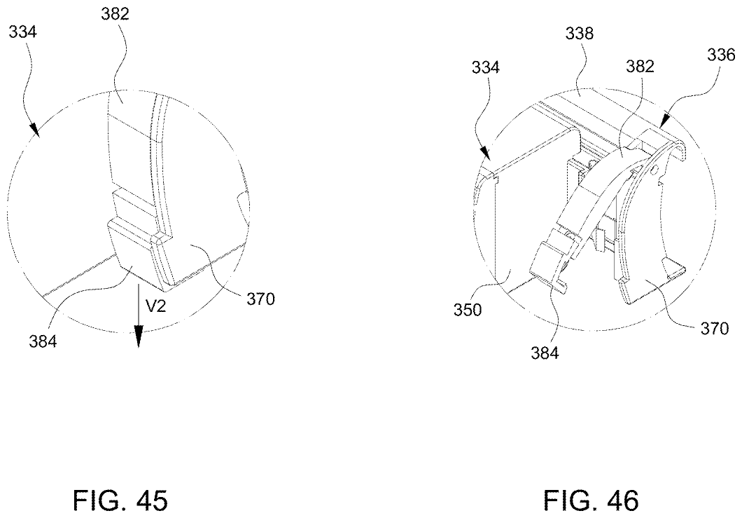

Referring to FIGS. 45 and 46, for removing the battery case 334, a user can operate and urge the latch 384 to slide in the direction V2 for disengaging from the groove 390 (better shown in FIG. 44) of the bracket 338. As a result, the clamping part 382 is released and can be rotated from the retaining position to the release position for disengaging from the anchoring portion 398. The battery case 334 is thereby unlocked, and can be removed from the battery case holder 336.

The advantages of the structures described herein include the ability to install and remove a battery case on a rail of an electrically-driven window shade as needed. As a result, the manual placement or replacement of battery cells can be facilitated and more convenient for the user.

Realizations of the structures have been described only in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the claims that follow.

What is claimed is:

1. A support structure for an electrically-driven window shade, comprising:
a rail configured to provide support for a shading structure of an electrically-driven window shade, the rail having a cavity adapted to receive an electric motor and being fixedly connected with a battery case holder having a plurality of first electric connectors; and
a battery case having a plurality of second electric connectors, the battery case having an interior configured to receive one or more battery cells, wherein the battery case is removable from the battery case holder and the rail for accessing to the interior of the battery case, and is connectable with the battery case holder so that the first electric connectors respectively contact with the second electric connectors for supplying electric power through the first and second electric connectors to an electric motor installed in the cavity of the rail.

2. The support structure according to claim 1, wherein the battery case holder is provided at an end of the rail.

3. The support structure according to claim 2, wherein the cavity of the rail is adapted to receive an electric motor adjacent to another end of the rail that is opposite to the end of the rail where is provided the battery case holder.

4. The support structure according to claim 1, wherein the rail has a bracket for attaching the battery case holder, the bracket being fixedly attached to the rail via at least a first fastener, and the battery case holder being fixedly attached to the bracket via at least a second fastener, the first fastener engaging with the bracket and the rail along a first axis, and the second fastener engaging with the battery case holder and the bracket along a second axis substantially orthogonal to the first axis, the second axis extending from a first end of the rail to a second end of the rail opposite to the first end.

5. The support structure according to claim 1, wherein the battery case is connectable with the battery case holder outside the rail.

6. The support structure according to claim 1, wherein the battery case includes a housing and a lid, the housing having an interior configured to receive one or more battery cells, the lid being positionable adjacent to the housing for covering at least partially the interior of the housing.

7. The support structure according to claim 1, wherein the battery case holder includes a casing having a cavity adapted to receive the battery case, the battery case being insertable into the cavity via an opening provided on the casing.

8. The support structure according to claim 7, further including a cover operable to close and uncover the opening of the casing.

9. The support structure according to claim 8, wherein the cover is positionable adjacent to the casing to close the opening of the casing, and is detachable and movable away from the casing to uncover the opening of the casing.

10. The support structure according to claim 8, wherein the cover is fixedly connected with the battery case, the opening of the casing being closed with the cover when the battery case is disposed inside the cavity of the casing.

11. The support structure according to claim 1, wherein the rail has a front surface and a rear surface, the front surface of the rail facing indoor in a use configuration, the battery case being movable in a direction toward the rear surface of the rail for connection with the battery case holder.

12. The support structure according to claim 1, further including a latch assembled with the battery case or the battery case holder, the latch being operable to lock the battery case in position relative to the battery case holder and the rail.

13. The support structure according to claim 12, wherein the latch and the second electric connectors are located at a same side of the battery case.

14. The support structure according to claim 12, wherein the latch is assembled with the battery case, the latch being movable relative to the battery case to engage with the battery case holder for locking the battery case in position relative to the battery case holder and the rail, or to disengage from the battery case holder for unlocking the battery case.

15. The support structure according to claim 14, wherein the battery case holder includes a coupling part having a connecting portion and an anchoring portion, and the battery case is slidable in contact with the connecting portion until the latch engages with the anchoring portion for locking the battery case in position relative to the battery case holder and the rail.

16. The support structure according to claim 14, wherein the latch is connected with a spring, the spring biasing the latch to engage with the battery case holder.

17. The support structure according to claim 14, wherein the latch has an actuating portion exposed for operation, the actuating portion being operable to cause the latch to disengage from the battery case holder.

18. The support structure according to claim 12, wherein the latch is assembled with the battery case holder, and the battery case has an anchoring portion, the latch being movable relative to the battery case holder to engage with the anchoring portion for locking the battery case to the battery case holder, or to disengage from the anchoring portion for unlocking the battery case so that the battery case is removable from the battery case holder.

19. The support structure according to claim 18, wherein the battery case holder includes a casing having a cavity adapted to receive the battery case, the battery case being insertable into the cavity via an opening provided on the casing, the latch being provided inside the cavity of the casing.

20. The support structure according to claim 19, further including a cover operable to close and uncover the opening of the casing, wherein the latch has an actuating portion operable to cause the latch to disengage from the battery case, the actuating portion being concealed inside the cavity of the casing and inaccessible when the cover closes the opening of the casing and exposed for operation when the opening of the casing is uncovered.

21. The support structure according to claim 1, wherein the battery case holder includes a bracket installable on a front face of the rail, and the battery case is connectable with the bracket outside the rail.

22. The support structure according to claim 21, wherein the bracket has a sidewall protruding at a front thereof, and the battery case holder further includes a latch mechanism disposed adjacent to the sidewall of the bracket for locking the battery case in position, the sidewall being located adjacent to an end of the battery case when the battery case is installed on the bracket of the battery case holder.

23. The support structure according to claim 22, wherein the latch mechanism includes a latch movably connected with the bracket, the latch being engaged with an anchoring portion provided on the battery case for locking the battery case in position with respect to the battery case holder, the anchoring portion being connected with a housing of the battery case.

24. The support structure according to claim 22, wherein the latch mechanism includes a clamping part and a latch, the clamping part being movable between a retaining position for engaging with an anchoring portion connected with a housing of the battery case and a release position for disengaging from the anchoring portion, and the latch being operable to lock the clamping part in the retaining position.

25. An electrically-driven window shade comprising:
the support structure according to claim 1;
a shading structure connected with the rail of the support structure; and
an electric motor disposed inside the rail of the support structure, wherein the electric motor is operable to expand the shading structure away from the rail of the support structure or retract the shading structure toward the rail of the support structure.
